(19) United States
(12) Patent Application Publication
(10) Pub. No.: US 2015/0378558 A1
(43) Pub. Date: Dec. 31, 2015

(54) SYSTEM AND METHOD FOR PROVIDING A USER-CONTROLLED OVERLAY FOR USER INTERFACE

(71) Applicant: Reliance Jio Infocomm USA, Inc., Plano, TX (US)

(72) Inventors: Nathan A. Smith, Frisco, TX (US); Jayabharath R. Goluguri, McKinney, TX (US); Ryan Wick, Apollo Beach, FL (US); Tom Bollwitt, Overland Park, KS (US)

(21) Appl. No.: 14/788,510

(22) Filed: Jun. 30, 2015

Related U.S. Application Data
(60) Provisional application No. 62/019,326, filed on Jun. 30, 2014.

(51) Int. Cl. G06F 3/0481; G06F 3/0485; G06F 3/0483; G06F 3/0488; G06F 3/0482

(52) U.S. Cl. CPC G06F 3/04817; G06F 3/0488; G06F 3/0482; G06F 3/0483; G06F 3/0485

(57) ABSTRACT

A system for controlling a device, comprising a user-controlled overlay configured to receive one or more user-entered controls and to generate a display on a screen of the device that includes a tab, a panel and a plurality of icons disposed within the panel. A touch screen controller configured to receive user-entered screen interface data from the screen and to generate coordinate data from the user-entered screen interface data. A processor coupled to the user-controlled overlay and the touch screen controller, the processor configured to modify the user-controlled overlay to generate a user-interface window for an application associated with a selected icon in response to the coordinate data. The user-controlled overlay includes a fly-out window associated with one or more of the icons, wherein the content of the fly-out window is generated from an alert received at a wireless interface of the device.

### RELATED APPLICATIONS

The present application claims priority to U.S. Provisional Patent Application No. 62/019,326, entitled “SYSTEM AND METHOD FOR PROVIDING A USER-CONTROLLED OVERLAY FOR USER INTERFACE,” filed on Jun. 30, 2014, which is hereby incorporated by reference for all purposes as if set forth herein in its entirety.

### TECHNICAL FIELD

The present disclosure relates generally to a user interface for a device, more specifically to a system and method for providing a user-controlled overlay for a user interface for a device that allows a user to quickly access applications that are operating on the device.

### BACKGROUND OF THE INVENTION

Devices such as smart phones can run many different applications. While this capability is useful, it also creates an environment that is difficult to navigate.

### SUMMARY OF THE INVENTION

A system for controlling a device is provided. The system includes a user-controlled overlay that receives user-entered controls and can generate a display on a screen of the device that includes a tab, a panel and a plurality of icons disposed within the panel. A touch screen controller receives user-entered screen interface data from the screen and generates coordinate data from the user-entered screen interface data. A processor coupled to the user-controlled overlay and the touch screen controller modifies the user-controlled overlay to generate a user-interface window for an application associated with a selected icon in response to the coordinate data. The user-controlled overlay includes a fly-out window associated with one or more of the icons, wherein the content of the fly-out window is generated from an alert received at a wireless interface of the device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a user interface with a first embodiment of a user-controlled overlay in accordance with an exemplary embodiment of the present disclosure;

FIG. 2 is a user interface with a second embodiment of a user-controlled overlay in accordance with an exemplary embodiment of the present disclosure;

FIG. 3 is a user interface with a third embodiment of a user-controlled overlay in accordance with an exemplary embodiment of the present disclosure;

FIG. 4 is a user interface with a fourth embodiment of a user-controlled overlay in accordance with an exemplary embodiment of the present disclosure;

FIG. 5 is a user interface with a fifth embodiment of a user-controlled overlay in accordance with an exemplary embodiment of the present disclosure;

FIG. 6 is a user interface with a sixth embodiment of a user-controlled overlay in accordance with an exemplary embodiment of the present disclosure;

FIG. 7 is a user interface with a seventh embodiment of a user-controlled overlay in accordance with an exemplary embodiment of the present disclosure;

FIG. 8 is a user interface with an eight embodiment of a user-controlled overlay in accordance with an exemplary embodiment of the present disclosure;

FIG. 9 is a flow chart of an algorithm for controlling a user-controlled overlay in accordance with an exemplary embodiment of the present disclosure;

FIG. 10 is a flow chart of an algorithm for configuring a user-controlled overlay in accordance with an exemplary embodiment of the present disclosure; and

FIG. 11 is a diagram of a system for controlling a user-controlled overlay in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

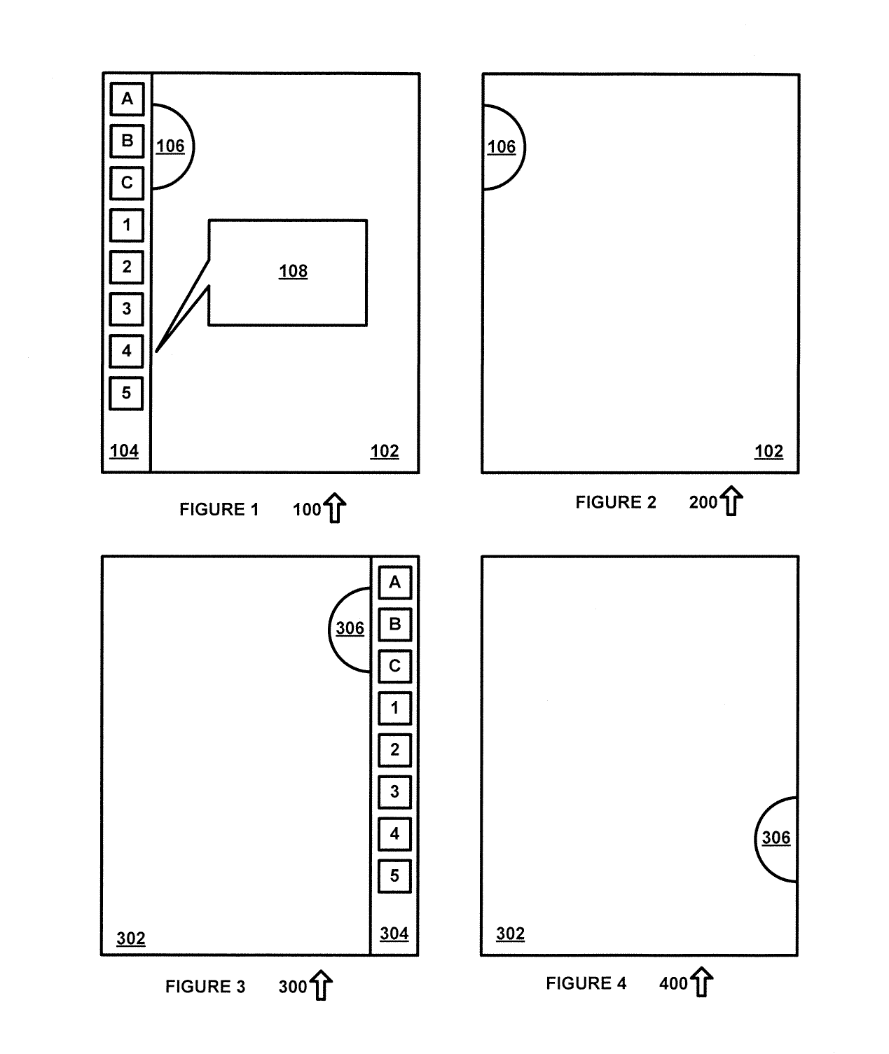

FIG. 1 is a user interface 100 with a first embodiment of a user-controlled overlay in accordance with an exemplary embodiment of the present disclosure. User interface 100 can be generated on a mobile device such as a smart cellular telephone, a tablet computer or a notebook computer, can be generated on a desktop computer, can be generated an appliance or can be generated on other suitable devices.

User interface 100 includes display screen 102, which can be used to display a background, a plurality of icons, one or more application screens or other suitable displays. User interface 100 further includes panel 104, which includes operator-controlled icons A, B and C and user-controlled icons 1, 2, 3, 4 and 5. Operator-controlled icons A, B and C can be selected by the wireless network operator, such as by configuring a boot-loaded program to generate a remote call to the network operator for the icons and associated hyperlinks. In this manner, the network operator can change the selection, configuration and other aspects of network operator-controlled icons A, B and C without having to reinstall a program in local memory of each wireless device in the network. User-controlled icons 1, 2, 3, 4 and 5 can be selected by the user. In one exemplary embodiment, network operator-controlled icons A, B and C and user-controlled icons 1, 2, 3, 4 and 5 can scroll, such as to display more than three operator-controlled icons and more than five user-controlled icons, where the “top slots” that are always on screen can be selected by the operator (for network operator-controlled icons A, B and C) and the user (for user-controlled icons 1, 2, 3, 4 and 5). Likewise, the number of icons shown can be modified, the size of the icons can be modified, the allocation of operator- and user-controlled icons can be modified, or other suitable modifications can also or alternatively be implemented. As discussed further herein, each of the applications associated with these icons can be opened in a top window of user display 102, so as to avoid the need for the user to close the currently-opened application that is in display screen 102. The user-controlled icons can also be sorted to show the most recently used icons in the top positions or in other suitable manners.

On aspect of the present disclosure is that network operator-controlled icons A, B and C do not need to be associated with an installed application on the device. In this exemplary embodiment, a network operator can include icons for new applications or other applications that are not installed on the user device and can send promotional alerts to a user to create an incentive for the user to install the application. In this manner, the fly-out display 108 can be used to activate application download and installation as well as to provide alerts for installed applications. Likewise, a software development kit can be provided to third parties to allow then to structure alerts for either uninstalled applications, or for applications with sensitive information (such as encrypted email applications), where the third party might not want to allow the network operator to access content contained within a message for the purpose of populating the fly-out display with data.

In another exemplary embodiment, the network operator-controlled icons A, B and C can be associated with geolocation data, such as nearby points of interest (mobile coupons for restaurants, lodging), nearby persons (persons on a friend list), can be tied to time of day alerts (specials for coffee in the morning, specials for lunch at mid-day), can be based on user behavior (alerts for items that the user has searched for), or can be other suitable alerts. In addition, the network operator-controlled icons can be theme-matched, as well as tab 106

Panel 104 is controlled by tab 106, which can be used to “pull” panel 104 out onto display screen 102 or to “push” panel 104 off display screen 102, in response to a user command. In one exemplary embodiment, display screen 102 can be implemented using a touch screen controller that generates user interface data responsive to a point of contact from a user's finger, a stylus or other suitable devices. The user interface data can include coordinate data for a point of contact that can be mapped to a current display of icons or other user interface display devices. If a point of contact correlates to tab 106 while panel 104 is currently off screen, and if a subsequent series of a points of contact form a vector pointing to the right-hand side of display screen 102, then the touch screen controller can generate control data to cause a processor to generate panel 104 with the associated icons on the left-hand side of display screen 102, with tab 106 adjacent to panel 104 in the location shown. Tab 106 can implemented as a logo of the network operator, such as where the logo transitions from a half-logo when the panel is hidden to a full logo when the panel is deployed. The tab can also be configured to be customized based on an associated holiday, to be customized by the user, to change colors or pulse if there are unviewed notifications, or to otherwise provide predetermined information to the user.

User interface 100 further includes fly-out display 108, which can be generated if a notification is received from a wireless interface. In one exemplary embodiment, a notification manager can receive notification data from a wireless interface and can transmit the notification to an associated application manager, such as a software system that has been instantiated and which is operating in the background in the operating system. The application manager can receive the notification data and transmit it to a manager for the user-controlled overlay, which can generate a fly-out display that contains some or all of the notification data. In one exemplary embodiment, the notification data can be generated for an incoming telephone call (to display the name of the caller, a picture of the caller, the caller's phone number, a history of calls for that caller or other suitable data), for a new text message (to display the name/picture/number/history for the sender of the message or other suitable data), for an installed application (such as to notify a user of an application-specific message), for an uninstalled application (such as to notify a user of a special offer to incentivize the user to install the application) or other suitable data. If the panel containing the icon associated with the fly-out is not presently on the screen, then the panel can open onto the screen with the associated icon displayed. Likewise, if the panel is presently shown on the screen but if the icon associated with the fly-out is not shown in the panel, the icons in the panel can scroll to the associated icon or other suitable processes can also or alternatively be used. The fly-out display can fade after a predetermined period of time, and the user can reactivate the fly-out display for an icon by tapping the display adjacent to the icon or in other suitable manners, where tapping the display is detected by the touch screen controller or other suitable devices and the associated icon is determined by the closest icon to the location of the tap or in other suitable manners.

Notification data can also be queued for a predetermined period of time, so as to be deleted after the user has had the opportunity to view them, within predetermined time after delivery or in other suitable manners. The message queue can also be used to retain messages until the user has reached a predetermined location, until a predetermined time has been reached, the messages can include rules for user interface functionality (such as by including one or more objects within each message that contain associated text data, graphical data and functional attributes), or other suitable messages can also or alternatively be used.

The location and functions of icons within a panel can also be monitored for all of the associated users, such as to determine which applications are of greatest interest to users. Notification data provided to users can also be analyzed, such as to determine which notifications have the highest success rates of being viewed or used, which notifications are viewed as a function of time of day or location, or other suitable analytics.

In operation, user interface 100 allows a user to access an application while any other application or process is being shown on the user display. Unlike prior art systems that require a user to minimize a display, navigate to an icon on a main screen and then select that icon to open new screen for the application associated with the icon, user interface 100 allows a user to search for and access a second application while they are contemporaneously viewing the first application on the main screen, and to return to the first application when they are finished with the second application, using a user-controlled overlay that can be configured and relocated based on a user's preferences.

FIG. 2 is a user interface 200 with a second embodiment of a user-controlled overlay in accordance with an exemplary embodiment of the present disclosure. User interface 200 can be generated on a mobile device such as a smart cellular telephone, a tablet computer or a notebook computer, can be generated on a desktop computer, can be generated an appliance or can be generated on other suitable devices.

User interface 200 shows display screen 102 with tab 106 adjacent to the left-hand side of display screen 102. In this exemplary embodiment, panel 104 is not visible and appears to be “off-screen” to the left-hand side of display screen 102. A user can modify the arrangement of tab 106 on display screen 102 using a suitable control, such as by selecting tab 106 and continuing to select tab 106 for a predetermined period of time, after which tab 106 can change color, shape, size, can appear to vibrate or can otherwise indicate that it has been selected. Tab 106 can then be moved to a new location around the perimeter of display screen 102.

FIG. 3 is a user interface 300 with a third embodiment of a user-controlled overlay in accordance with an exemplary embodiment of the present disclosure. User interface 300 can be generated on a mobile device such as a smart cellular telephone, a tablet computer or a notebook computer, can be generated on a desktop computer, can be generated an appliance or can be generated on other suitable devices.

User interface 300 shows display screen 302 with panel 304 and tab 306, where panel 304 includes operator-controlled icons A, B and C and user-controlled icons 1, 2, 3, 4 and 5. By relocating tab 106 to the position of tab 306, the user is able to change the location of panel 104 to the location of panel 304. The processor can access one or more display templates for locations for panels 104 and 304, such as a left-hand side display position, a right-hand side display position, a top of screen display position and a bottom of screen display position, such that when a user changes the location of tab 106/306, the associated panel is automatically configured.

FIG. 4 is a user interface 400 with a fourth embodiment of a user-controlled overlay in accordance with an exemplary embodiment of the present disclosure. User interface 400 can be generated on a mobile device such as a smart cellular telephone, a tablet computer or a notebook computer, can be generated on a desktop computer, can be generated an appliance or can be generated on other suitable devices.

User interface 400 shows tab 306 on the right-hand side of display screen 302, with panel 304 off screen. In addition, tab 306 has been relocated by the user to a position at the bottom right hand side of the screen. In this manner, a user can configure the overlay to be in the position and to have the associated icons that are of interest to the user.

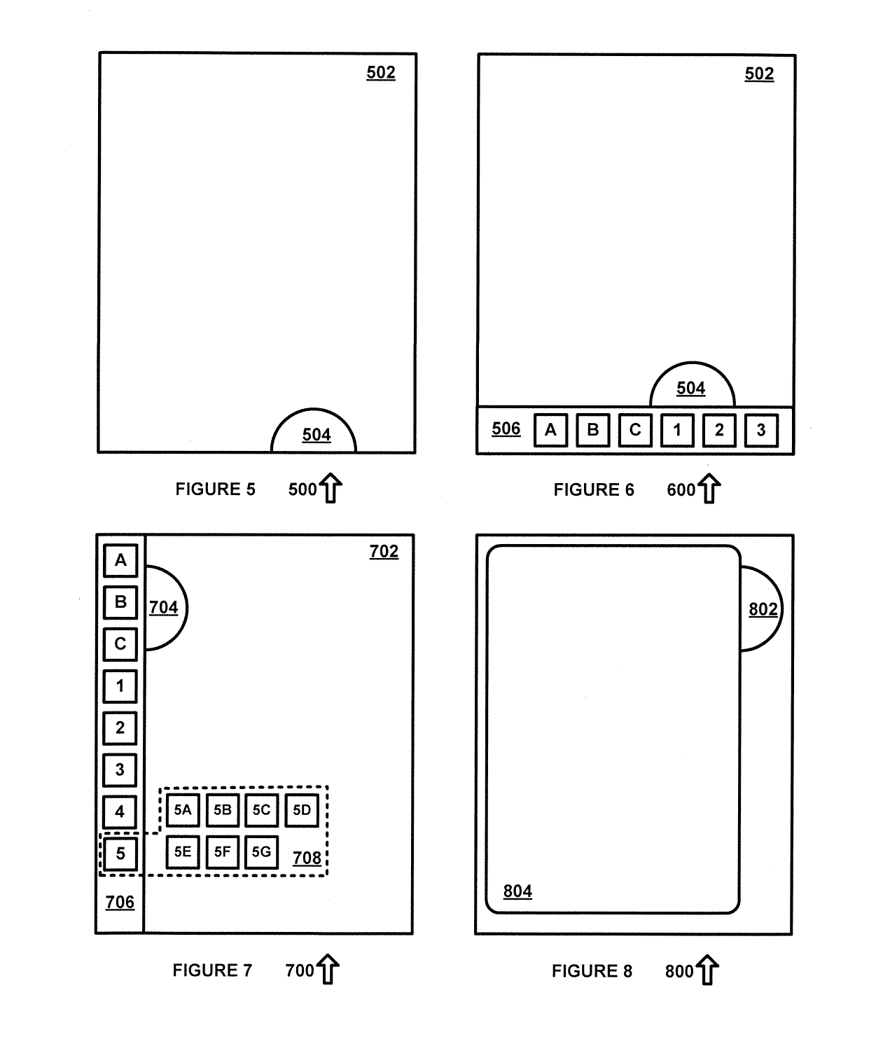

FIG. 5 is a user interface 500 with a fifth embodiment of a user-controlled overlay in accordance with an exemplary embodiment of the present disclosure. User interface 500 can be generated on a mobile device such as a smart cellular telephone, a tablet computer or a notebook computer, can be generated on a desktop computer, can be generated an appliance or can be generated on other suitable devices.

User interface 500 shows tab 504 on the bottom of display screen 502, with the associated panel off screen. In addition, tab 504 has been relocated by the user to a position at the bottom of the screen. In this manner, a user can configure the overlay to be in the position and to have the associated icons that are of interest to the user.

FIG. 6 is a user interface 600 with a sixth embodiment of a user-controlled overlay in accordance with an exemplary embodiment of the present disclosure. User interface 600 can be generated on a mobile device such as a smart cellular telephone, a tablet computer or a notebook computer, can be generated on a desktop computer, can be generated an appliance or can be generated on other suitable devices.

User interface 600 shows tab 504 on the bottom of display screen 502, with panel 506 also on the bottom of display screen 502. Panel 506 includes operator-controlled icons A, B and C, and user-controlled icons 1, 2 and 3. In this manner, a user can configure the overlay to be in the position and to have the associated icons that are of interest to the user.

FIG. 7 is a user interface 700 with a seventh embodiment of a user-controlled overlay in accordance with an exemplary embodiment of the present disclosure. User interface 700 can be generated on a mobile device such as a smart cellular telephone, a tablet computer or a notebook computer, can be generated on a desktop computer, can be generated an appliance or can be generated on other suitable devices.

User interface 700 includes display screen 702, which includes tab 704 and panel 706. In addition to operator-controlled icons A, B and C, and user-controlled icons 1, 2, 3, 4 and 5, a folder display 708 is shown that includes icons 5A through 5G that are associated with icon 5. In this manner, a user can configure the user-controlled overlay to include additional icons that can be accessed by placing folders in panel 706 instead of individual application icons, so as to increase the number of icons that are accessible though the user-controlled overlay. Any one of these additional icons can be selected and an associated application can be activated or opened (in a multi-window environment), in order to allow the user to quickly navigate to a second application while operating a first application.

FIG. 8 is a user interface 800 with an eighth embodiment of a user-controlled overlay in accordance with an exemplary embodiment of the present disclosure. User interface 800 can be generated on a mobile device such as a smart cellular telephone, a tablet computer or a notebook computer, can be generated on a desktop computer, can be generated an appliance or can be generated on other suitable devices.

User interface 800 includes second level display 804, which includes tab 802. When a user selects an application from a panel of the user-controlled overlay, the application can be opened within second level display 804, which can allow the user to interact with the application in the same manner that the user would otherwise normally interact with the application. When the user is finished, tab 802 can be used to close second level display 804, and to return the user to the application or other data shown in the display screen.

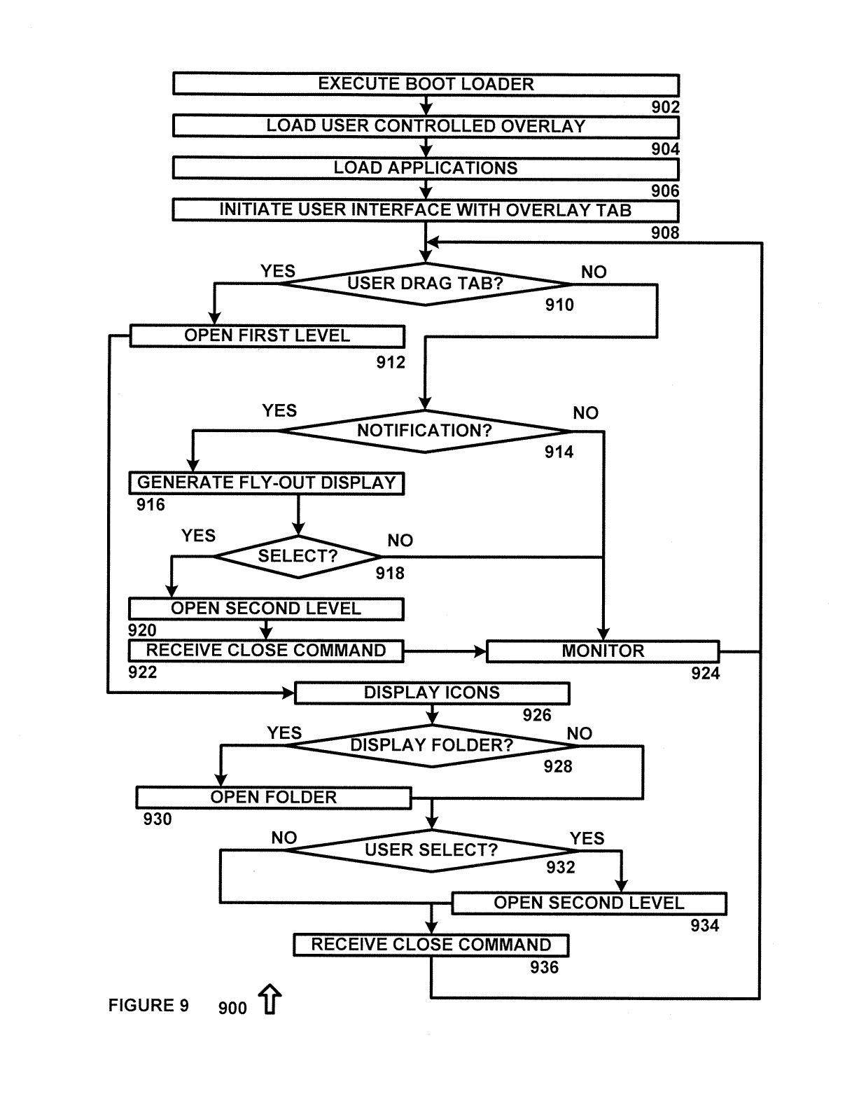

FIG. 9 is a flow chart of an algorithm 900 for controlling a user-controlled overlay in accordance with an exemplary embodiment of the present disclosure. Algorithm 900 can be implemented in hardware or a suitable combination of hardware and software, and can be one or more software systems operating on one or more processors.

Algorithm 900 begins at 902, where a boot loader program is executed, such as when a mobile device is turned on. In one exemplary embodiment, the boot loader contains a series of commands that are used to initialize the mobile device, run self-tests, start the operating system and perform other suitable functions. The algorithm then proceeds to 904.

At 904, a user-controlled overlay is executed. In one exemplary embodiment, the user-controlled overlay can be executed after the execution of the operating system and prior to the execution of any applications, to configure the user-controlled overlay to monitor the initialization and execution of applications, such as to allow the user-controlled overlay to receive alert data for installed applications, uninstalled applications and other suitable alerts. The algorithm then proceeds to 906.

At 906, one or more applications are loaded on the device. The applications can include a text messaging application, an electronic mail application, a calendar application, an audiovisual file player application, a web browser application and other suitable applications. The algorithm then proceeds to 908.

At 908, a user interface is initiated with a user-controlled overlay tab. In one exemplary embodiment, the user interface can include a tab control that is shown on-screen at a predetermined location around the perimeter of the screen, so as to allow a user to activate the tab control without inadvertently activating an off-screen pull-down display, a left or right scrolling feature or other controls or features. The algorithm then proceeds to 910.

At 910, it is determined whether a user has dragged the tab away from the side of the user interface. In one exemplary embodiment, a touch screen controller can be used to detect coordinates where a user has touched a screen with their finger, a stylus or other suitable devices, and can correlate those coordinates with the coordinates of graphic images on the user interface, including the tab display or icon. If it is determined that the user has touched the user interface display at the tab control and has then continued to touch the user interface display in a direction that has an associated movement vector directed away from the side of the display towards the center of the display, then the algorithm proceeds to 912, where a first level display such as a panel of icons is generated. Otherwise, the algorithm proceeds to 914.

At 914, it is determined whether a notification has been received. In one exemplary embodiment, a notification feature of the operating system can monitor incoming data packets from a wireless or wireline network connection to determine whether any packets contain notification data associated with one or more applications, such as an incoming telephone call, an incoming text message, an incoming email message or other suitable notification data. If it is determined that no notification data has been received, the algorithm proceeds to 924, where the user interface or other input controls are monitored for additional user inputs, and the algorithm returns to 910. If it is determined that notification data has been received at 914, the algorithm proceeds to 916.

At 916, a fly-out display is generated. In one exemplary embodiment, the fly-out display can include data from the notification data, such as data identifying the calling party for an incoming telephone call, data identifying the sender of a text message for an incoming text message or other suitable data. In another exemplary embodiment, the notification data can include a daily special associated with an audiovisual player, an application store or other suitable applications, where the objective of the notification is to market items (songs, videos, applications) for purchase, to provide rewards or other incentives, or for other suitable purposes. The algorithm then proceeds to 918.

At 918, it is determined whether a selection has been made in response to the fly-out display. If it is determined that a selection has not been made after a predetermined period of time, then the algorithm proceeds to 924, where the user interface and incoming data is monitored for another cycle. Otherwise, the algorithm proceeds to 920, where a second level display is opened. The second level display can include a user prompt to install an application if the notification related to an application that the user has not yet installed, a sub-window for an application to operate in and for the user to interface with, or other suitable displays. The algorithm then proceeds to 922, where a close command is received. In one exemplary embodiment, the close command can include touch screen interface data that shows a user touched the display at a location that correlates with a tab associated with the second level display and then dragged the user's finger, stylus or other suitable item in a direction across the second level display and towards the edge of the user interface, or other suitable controls. The algorithm then proceeds to 924.

After a first level display is opened at 912, the algorithm proceeds to 926, where a plurality of icons is displayed in a panel along a side of a user interface display or in other suitable manners. The algorithm then proceeds to 928, where it is determined whether a user has selected an icon associated with a folder, such as by monitoring coordinates generated by a touch screen interface and comparing those to coordinates of an icon for a folder or in other suitable manners. If it is determined that an icon associated with a folder has not been selected, the algorithm proceeds to 932, where the folder associated with the selected folder icon is opened and a plurality of icons representing the applications in that folder are displayed in an area adjacent to the folder icon in the panel, or in other suitable manners. The algorithm then proceeds to 932.

At 932, it is determined whether a user selection of an icon has been made, such as by monitoring coordinate data generated by a touch screen controller or in other suitable manners. If a user selection of an icon has been made, the algorithm proceeds to 934, where a second level display is opened for the selected icon. In one exemplary embodiment, the information contained within the second level display can be the same information that the user would see if they were to close an existing open display and navigate to a display associated with the icon using the normal interaction processes for the device in a multi-window or multi-tasking mode, such as by scrolling through screens and opening folders. The algorithm then proceeds to 936 where a close command is received and the second level window is closed. The algorithm then returns to 910.

In operation, algorithm 900 allows a user to interface with a user interface that includes a user-controlled overlay. Although algorithm 900 is shown as a flow chart, algorithm 900 can also or alternatively be implemented as a state diagram, with object-oriented programming or in other suitable manners. Likewise, monitoring of touch screen control data, incoming wireless data and other suitable functions does not need to be performed as part of a single cycle, and separate processes can be independently monitored.

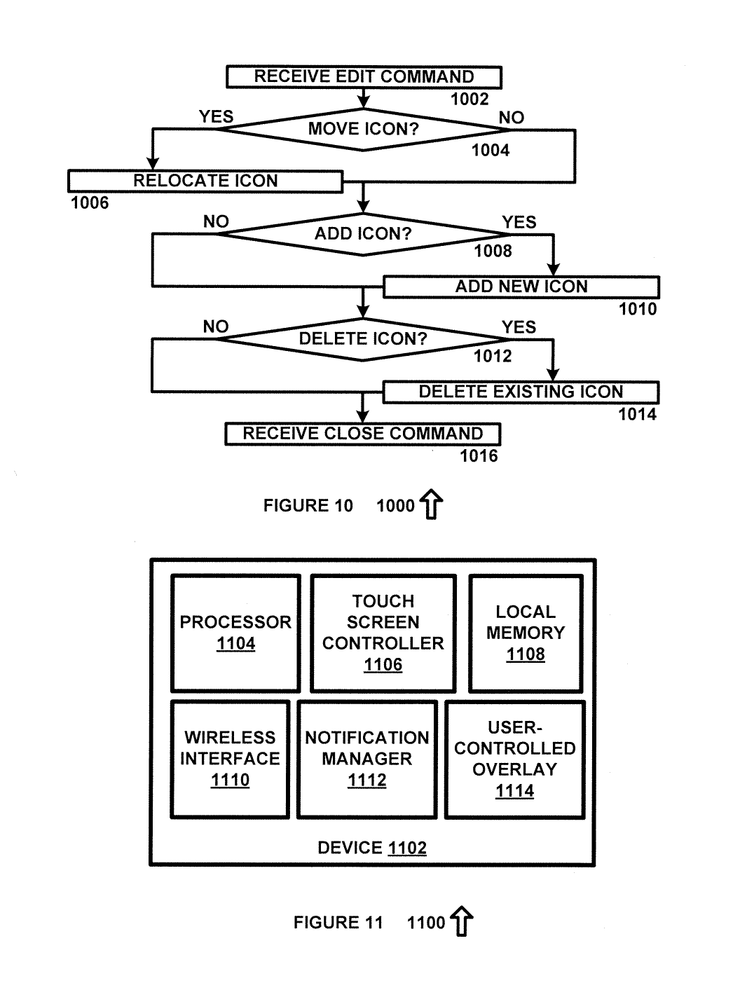

FIG. 10 is a flow chart of an algorithm 1000 for configuring a user-controlled overlay in accordance with an exemplary embodiment of the present disclosure. Algorithm 1000 can be implemented in hardware or a suitable combination of hardware and software, and can be one or more software systems operating on one or more processors.

Algorithm 1000 begins at 1002, where an edit command is received. In one exemplary embodiment, the edit command can include touching and holding an icon on a touch screen display user interface or other suitable commands. The algorithm then proceeds to 1004.

At 1004, it is determined whether a command has been received to move the icon. In one exemplary embodiment, the icon can be a tab of a user-controlled overlay or other suitable controllers that are used to control a location of a user-controlled overlay. In another exemplary embodiment, the icon can be an icon within a panel or other suitable icons. If it is determined that a command to move the icon has been received, the algorithm proceeds to 1006, where the icon is relocated. In one exemplary embodiment, a control tab for the user-controlled overlay can be moved to a new location around the perimeter of the display, and an associated panel for the user-controlled overlay can also be reconfigured, if necessary. In another exemplary embodiment, the icon can be relocated to a new location within a panel, a folder subpanel or other suitable locations. The algorithm then proceeds to 1008.

At 1008, it is determined whether a command has been received to add a new icon to a panel or sub-panel. If not, then the algorithm proceeds to 1012, otherwise the algorithm proceeds to 1010 where the new icon is added to the panel or sub-panel. In one exemplary embodiment, a user can select from a scrolling list of icons for all available programs, or other suitable processes can also or alternatively be used. The algorithm then proceeds to 1012.

At 1012, it is determined whether an icon is to be deleted, such as by selecting a delete icon or in other suitable manners. If it is determined that the icon is to be deleted, the algorithm proceeds to 1014 where the icon is deleted and the other icons having a lower rank are shifted upwards in the order, or other suitable processes are also or alternatively used, and the algorithm proceeds to 1016. Likewise, if no icon is to be deleted at 1012, the algorithm proceeds to 1016, where a close command is received.

In operation, algorithm 1000 allows a user to reconfigure a user-controlled overlay. Although algorithm 1000 is shown as a flow chart, algorithm 1000 can also or alternatively be implemented as a state diagram, with object-oriented programming or in other suitable manners.

FIG. 11 is a diagram of a system 1100 for controlling a user-controlled overlay in accordance with an exemplary embodiment of the present disclosure. System 1100 includes processor 1102, touch screen controller 1104, local memory 1106, wireless interface 1108, notification manager 1110 and user controlled overlay 1112, each of which can be implemented in hardware or a suitable combination of hardware and software. Processor 1102 can be a processor of a mobile device, such as a microprocessor, a reduced instruction set (RISC) processor or other suitable processers. Touch screen controller 1104 can be a capacitive touch screen interface and associated controller logic for detecting a location where the touch screen was activated. Local memory 1106 can be one or more memory devices, such as read-only memory, random access memory or other suitable memory devices. Wireless interface 1108 can be a 4G wireless data system, an 802.xx local wireless network interface, a Bluetooth wireless network interface or other suitable wireless data transceivers. Notification manager 1110 can be part of an operating system, wireless data manager or other suitable system that processes data received over the wireless network or other communications media and extracts data packets associated with applications, such as new incoming email or text messages, new incoming calls or other suitable data. User controlled overlay 1112 controls a user-interface overlay that allows a user to access shortcut icons to applications operating on the device.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for controlling a device, comprising:
a user-controlled overlay configured to receive one or more user-entered controls and to generate a display on a screen of the device that includes a tab, a panel and a plurality of icons disposed within the panel;
a touch screen controller configured to receive user-entered screen interface data from the screen and to generate coordinate data from the user-entered screen interface data;
a processor coupled to the user-controlled overlay and the touch screen controller, the processor configured to modify the user-controlled overlay to generate a user-interface window for an application associated with a selected icon in response to the coordinate data; and
wherein the user-controlled overlay includes a fly-out window associated with one or more of the icons, wherein the content of the fly-out window is generated from an alert received at a wireless interface of the device.

2. The system of claim 1, wherein the panel and the plurality of icons are not displayed on the screen in a first state and are displayed on the screen in a second state.

3. The system of claim 1, wherein the panel, the plurality of icons and the tab can be relocated by a user.

4. The system of claim 1, wherein the panel, the plurality of icons and the tab can be relocated by a user by relocating the tab from a first perimeter edge of the screen to a second perimeter edge of the screen.

5. The system of claim 1, wherein the user-controlled overlay further comprises a folder display containing a plurality of icons that is generated when a folder icon in the panel is selected by a user.

6. The system of claim 1, wherein the plurality of icons comprises a plurality of icons that are selected by a network operator and a plurality of icons that are selected by a user.

7. The system of claim 1, wherein the plurality of icons can be scrolled within the panel.

8. A method for controlling a display, comprising:
launching a boot loader of the device;
launching a user-controlled overlay of the device;
launching a plurality of applications of the device; and
generating a display on a screen of the device that comprises the user-controlled overlay and an icon for each of the plurality of applications.

9. The method of claim 8 wherein the user-controlled overlay comprises a tab that is shown on the screen in a first state and a panel containing a subset of the plurality of icons that is shown on the screen in the second state and not in the first state.

10. The method of claim 8 further comprising:
receiving an alert; and
generating a fly-out display for one of the icons in the panel.

11. The method of claim 9 further comprising relocating the panel in response to a user control.

12. The method of claim 9 further comprising relocating the plurality of icons in response to a user control.

13. The method of claim 9 further comprising relocating the tab in response to a user control.

14. The method of claim 9 further comprising relocating the panel, the plurality of icons and the tab by a user by relocating the tab from a first perimeter edge of the screen to a second perimeter edge of the screen.

15. The method of claim 9 further comprising generating a folder display containing a plurality of icons when a folder icon in the panel is selected by a user.

16. The method of claim 8 further comprising:
selecting a first plurality of icons by a network operator; and
selecting a second plurality of icons by a user.

17. The method of claim 8 further comprising scrolling the plurality of icons within s panel.

18. The method of claim 9 further comprising relocating the panel by a user by relocating the tab from a first perimeter edge of the screen to a second perimeter edge of the screen.

19. The method of claim 9 further comprising relocating the plurality of icons by a user by relocating the plurality of icons from a first perimeter edge of the screen to a second perimeter edge of the screen.

20. In a system for controlling a device having a user-controlled overlay configured to receive one or more user-entered controls and to generate a display on a screen of the device that includes a tab, a panel and a plurality of icons disposed within the panel, a touch screen controller configured to receive user-entered screen interface data from the screen and to generate coordinate data from the user-entered screen interface data, a processor coupled to the user-controlled overlay and the touch screen controller, the processor configured to modify the user-controlled overlay to generate a user-interface window for an application associated with a selected icon in response to the coordinate data, wherein the user-controlled overlay includes a fly-out window associated with one or more of the icons, wherein the content of the fly-out window is generated from an alert received at a wireless interface of the device, wherein the panel and the plurality of icons are not displayed on the screen in a first state and are displayed on the screen in a second state, wherein the panel, the plurality of icons and the tab can be relocated by a user, wherein the panel, the plurality of icons and the tab can be relocated by a user by relocating the tab from a first perimeter edge of the screen to a second perimeter edge of the screen, wherein the user-controlled overlay further comprises a folder display containing a plurality of icons that is generated when a folder icon in the panel is selected by a user, wherein the plurality of icons comprises a plurality of icons that are selected by a network operator and a plurality of icons that are selected by a user, and wherein the plurality of icons can be scrolled within the panel, the method comprising:
launching a boot loader of the device;
launching a user-controlled overlay of the device;
launching a plurality of applications of the device;
generating a display on a screen of the device that comprises the user-controlled overlay and an icon for each of the plurality of applications;
receiving an alert;
generating a fly-out display for one of the icons in the panel;
relocating the panel in response to a user control;
relocating the plurality of icons in response to a user control;
relocating the tab in response to a user control;
relocating the panel, the plurality of icons and the tab by a user by relocating the tab from a first perimeter edge of the screen to a second perimeter edge of the screen;
generating a folder display containing a plurality of icons when a folder icon in the panel is selected by a user;
selecting a first plurality of icons by a network operator;
selecting a second plurality of icons by a user;
scrolling the plurality of icons within s panel;
relocating the panel by a user by relocating the tab from a first perimeter edge of the screen to a second perimeter edge of the screen;
relocating the plurality of icons by a user by relocating the plurality of icons from a first perimeter edge of the screen to a second perimeter edge of the screen; and
wherein the user-controlled overlay comprises a tab that is shown on the screen in a first state and a panel containing a subset of the plurality of icons that is shown on the screen in the second state and not in the first state.
